(19) United States
(12) Patent Application Publication
(10) Pub. No.: US 2025/0337222 A1
(43) Pub. Date: Oct. 30, 2025

(54) ASSEMBLY FOR AN OVERVOLTAGE PROTECTION DEVICE, OVERVOLTAGE PROTECTION DEVICE AND METHOD FOR PRODUCING AN ASSEMBLY

(71) Applicant: DEHN SE, Neumarkt i.d.OPf. (DE)

(72) Inventors: Michael Berschneider, Berg (DE); Patrick Eichenseer, Kastl (DE); Bernd Leibig, Sulzbach-Rosenberg (DE); Florian Gäck, Beilngries (DE); Sascha Ludewig, Neumarkt (DE); Edmund Zäuner, Berching/Pollanten (DE); Herbert Krämer, Heideck (DE); Peter Fritz, Parsberg (DE); Michael Mohren, Denkendorf (DE); Christian Himmelstoss, Falkenstein (DE); Bernhard Lommer, Waffenbrunn (DE); Bernhard Wutz, Waldmünchen (DE); Daniel Babl, Waldmünchen (DE)

(21) Appl. No.: 18/869,834

(22) PCT Filed: Jun. 5, 2023
(86) PCT No.: PCT/EP2023/064982

§ 371 Date: Nov. 26, 2024

(30) Foreign Application Priority Data
Jun. 8, 2022 (DE) 20 2022 103 235.1

(51) Int. Cl. H01T 1/14; H01C 7/12; H01H 9/16; H01H 37/74; H01H 83/10

(52) U.S. Cl. CPC H01T 1/14; H01C 7/126; H01H 9/167; H01H 37/74; H01H 83/10

(57) ABSTRACT

The invention relates to an assembly for a surge protection apparatus (10), comprising a disconnecting device (18) which includes a spring arm (20) having an end-side contact point (24) and a holding element (22). The holding element (22) and the contact point (24) are opposite each other in an initial position of the assembly (11). A thermally softenable material (26) is provided between the holding element (22) and the contact point (24) which connects the spring arm (20) both mechanically and electrically to the holding element (22). The assembly (11) has a remote signaling contact (50) which has a mechanical separating point (48). The spring arm (20), the holding element (22) and the remote signaling contact (50) are produced from a common stamped metal sheet (14). The stamped metal sheet (14) is at least partially insert-molded with a plastic material which forms a frame (16) The invention furthermore relates to a surge protection apparatus.

The invention relates to an assembly for a surge protection apparatus and to a surge protection apparatus. The invention furthermore relates to a method of manufacturing an assembly.

It is known from the prior art that a surge protection apparatus is used to protect electrical components from overstress if they have to work outside their nominal operating range.

In this regard, it is known, for example, that a thermal separating point is provided which triggers when contacts of the thermal separating point heat up due to the overstress, for example due to a corresponding current. Due to the thermal load which occurs, a thermally softenable material, for example, which is part of the thermal separating point, softens, which interrupts an electrical connection. Such an arrangement is known, for example, from document DE 10 2011 100 437 B4, in which, however, numerous components are required which have to be coupled to each other to provide the corresponding functionality. This makes manufacture and assembly accordingly more complicated, which in turn results in higher costs.

In any case, the thermal separating point ensures that a component to be protected is disconnected in a correspondingly short time in the event of thermal overload.

In addition, it is known from the prior art that a separately designed separating point of a remote signaling circuit is formed by means of two gold contacts, which, however, leads to correspondingly high costs due to the material used.

The object of the invention is to enable a surge protection apparatus having a corresponding disconnecting device which can be manufactured in a cost-effective manner.

According to the invention, the object is achieved by an assembly for a surge protection apparatus, comprising a disconnecting device which includes a spring arm having an end-side contact point and a holding element. The holding element and the contact point are opposite each other in an initial position of the assembly, wherein a thermally softenable material is provided between the holding element and the contact point which connects the spring arm both mechanically and electrically to the holding element. The assembly has a remote signaling contact which has a mechanical separating point. The spring arm, the holding element and the remote signaling contact are produced from a common stamped metal sheet. The stamped metal sheet is at least partially insert-molded with a plastic material which forms a frame.

The basic idea of the invention is to provide a simply designed disconnecting device which can be integrated into a surge protection apparatus. At the same time, the remote signaling contact is formed with the mechanical separating point. This is possible as the holding element, the spring arm and the remote signaling contact are manufactured from one piece of material, namely the common stamped metal sheet, so that at least these three components are formed from one part, namely the spring arm, the holding element and the remote signaling contact.

It is therefore no longer necessary to provide several separately manufactured components which have to be mounted individually, resulting in correspondingly high assembly and manufacturing costs. Consequently, the assembly according to the invention can be manufactured more easily, more quickly and thus more cost-effectively.

In addition, the stamped metal sheet, i.e. the components formed from the stamped metal sheet, can be directly insert-molded by the plastic material, so that the frame is formed on which corresponding functional components necessary for the functioning of the disconnecting device may be provided. This also results in cost advantages, as the frame made of plastic material can directly include the required functional components, so that these components do not have to be manufactured separately and then assembled. The number of required components can thus be reduced, which in turn reduces the manufacturing and assembly costs accordingly.

The plastic material serves in particular to hold the various components made of the stamped metal sheet metal, i.e. the remote signaling contact with the mechanical separating point, the holding element and the spring arm having the contact point. This is achieved by the components made from the common stamped metal sheet metal being at least partially embedded in the frame, i.e. being insert-molded by the plastic material from which the frame is formed.

In this respect, cost-effective production can be achieved, especially for large quantities.

In particular, a stamped grid is provided. The stamped grid corresponds to a system of electrical conductors made from a metal strip, for example the stamped metal sheet. In this respect, the stamped grid resembles a printed circuit board.

The stamped metal sheet thus has been pre-processed into a stamped grid, in particular before the plastic material has been injection molded around it. For this purpose, the stamped metal sheet may have been previously formed and/or stamped to thus obtain a three-dimensional stamped grid.

In addition, the stamped metal sheet, in particular the electrical conductors, may have been at least partially galvanized, for example, corresponding surfaces.

In addition to the three above-mentioned components of the assembly, which have been realized from the stamped metal sheet, i.e. the spring arm, the holding element and the remote signaling contact, two contacts for the electrical connection of the disconnecting device and electrodes for an electrical component may also be formed by the stamped metal sheet.

Consequently, the stamped metal sheet provides numerous components of the assembly, in particular up to seven different components. For example, the numerous components are formed by parts which are formed separately and obtained from the stamped metal sheet. In this case, a part may also comprise more than one component.

A first plug contact may be formed integrally with the spring arm. The holding element may be formed integrally with one of the electrodes for the electrical component. Furthermore, the second electrode for the electrical component may be electrically conductively coupled to a second plug contact in the assembled state.

The remote signaling contact may be formed separately from the other components, but can still be held by the frame formed from the plastic material.

In the initial state, a current flows via the first plug contact and the spring arm, which is integrally formed therewith, to the holding element, as the connection between the contact point and the holding element is closed, i.e. the thermal separating point. The holding element is integrally formed with the first electrode for the electrical component, so that the current then flows from the first electrode through the electrical component to the second electrode, which may be formed by a contact plate, the second electrode being electrically conductively coupled to the second plug contact, so that the current can flow via the second plug contact.

The remote signaling contact may be present in a remote signaling circuit through which a current flows. As soon as the assembly triggers, both the current flow via the thermal separating point is interrupted and the mechanical separating point of the remote signaling contact is mechanically disconnected, as a result of which the current flow of the remote signaling circuit is interrupted.

In principle, the thermally softenable material may ensure a connection by an intermaterial bond between the holding element and the contact point of the spring arm in the initial position of the assembly.

When mounting the assembly, it may be provided that the thermally softenable material has first been applied onto the holding element, so that the spring arm has been formed, in particular bent, later so that the contact point at the end of the spring arm comes into contact with the thermally softenable material. The mechanical and electrical connection can then be established by means of an inductive soldering process, for example.

The thermally softenable material is applied in particular after the components formed from the stamped metal sheet have been embedded in the plastic material, i.e. embedded in the frame.

One aspect provides that a thermal separating point between the holding element and the contact point is formed by means of the thermally softenable material. The mechanical and electrical connection between the contact point of the spring arm and the holding element can thus be thermally opened if the thermally softenable material is heated. Consequently, the state of the thermally softenable material changes when it is heated, in particular above a defined temperature.

The thermally softenable material is a solder, for example. Accordingly, a solder connection is provided between the holding element and the contact point.

Alternatively, an electrically conductive adhesive may be provided which is temperature-sensitive and softens when the adhesive is heated.

The spring arm may have a projection which enters an opening provided in the holding element, in particular in the area of the contact point. The projection may also be referred to as a tab. The projection may have a height which is greater than the material thickness of the holding element. The projection thus penetrates the holding element. Greater surface contact may be realized, for example on at least two surfaces which are perpendicular to each other, namely the surface of the spring arm from which the projection projects, and sides of the projection which are associated with the edge of the opening in the holding element.

A further aspect provides that the assembly has a lever which is used to mechanically separate the mechanical separating point of the remote signaling contact and/or to open the connection between the holding element and the contact point in a defined manner. The lever is therefore intended, among other things, to disconnect the electrical and mechanical connection between the holding element and the contact point in a defined manner. The shape of the lever arm ensures that when the connection between the holding element and the contact point is opened, the spring arm moves so far to prevent an arc from occurring between the contact point and the holding element. This is to be understood as the defined opening of the thermal separating point.

In addition, the lever may be designed to mechanically open, i.e. to mechanically interrupt the mechanical separating point of the remote signaling contact.

In particular, both occur (substantially) simultaneously, i.e. the mechanical interruption of the mechanical separating point and the (defined) opening of the thermal separating point. The lever acts both on the thermal separating point (indirectly via the spring arm) and on the mechanical separating point (directly).

The lever may have a first lever arm which cooperates with a preloading element. The preloading element may be an elastically preloaded preloading element, for example a spring element. The preloading force applied by the preloading element to the first lever arm is converted into a lever force by the shape of the lever, which acts on the spring arm, causing a separating force to act on the connection between the holding element and the contact point. If the separating force is greater than the holding force generated by the thermally softenable material, then the connection is disconnected accordingly. However, this is only possible if the holding force of the thermally softenable material, which is provided between the holding element and the contact point, decreases due to thermal action (heating). The preloading element and the design of the lever ensure that a defined lever force is present, which acts on the spring arm. The spring arm is in turn designed such that a defined separating force acts on the thermally softenable material. In other words, the separating force can be adjusted by the design of the preloading element, the lever and the spring arm. The design is such that the holding force generated by the thermally softenable material in the initial state is initially not exceeded by the separating force.

The elastically preloaded preloading element accordingly presses on the first lever arm of the lever, the preloading force thus acting on the first lever arm, which, among other things, is transmitted to the thermally softenable material via the lever.

The lever may have a second lever arm which is opposite to the first lever arm. In principle, a distance may be provided between the end of the second lever arm and the spring arm, which ensures that the thermal separating point and the remote signaling contact are disconnected first.

The second lever arm may act on the spring arm via at least one section to assist in opening or to hold the spring arm in an open position. The lever force generated by the preloading element by means of the lever can be adjusted by the design of the lever, in particular of the two lever arms.

In addition, the separating force acting on the thermally softenable material may be adjusted by the design of the spring arm on which the second lever arm acts.

The lever may have reinforcing ribs or a timber-framed structure, which ensures that the lever does not twist. Due to the reinforcing ribs or the timber-framed structure, the lever may have a low weight for the achieved rigidity, in particular in comparison with a lever made of a solid material having the same rigidity.

A further aspect provides that the lever is provided with a pin which interacts with the mechanical separating point of the remote signaling contact. The pin may protrude laterally from a base body of the lever. In this respect, the pin extends in a direction which is (substantially) perpendicular to the extension directions of the two lever arms of the lever. When the lever moves from its initial position to the triggered position, which may also be referred to as the end position or end location, the pin arranged on the lever moves with the lever, causing it to cut or interrupt the mechanical separating point of the remote signaling contact.

The pin may therefore be referred to as a pivot pin, since the pin performs a pivoting movement when the lever moves from the initial position to the triggered position. In its end position associated with the triggered position, the pin ensures, among other things, that the disconnected section of the remote signaling contact cannot move back to its initial position. This ensures the clearance and creep distances.

The lever itself may also be an injection-molded part.

The frame formed from the plastic material may have a bearing for the lever. The bearing defines the axis of rotation of the lever, about which the lever can rotate when the assembly triggers and switches to the triggered state. Since the bearing for the lever is formed by the plastic material itself, it is not necessary to provide a separate bearing which would first have to be attached to a carrier. This simplifies assembly and manufacture. In particular, the lever is simply placed on the bearing formed by the plastic material during assembly.

Furthermore, the frame formed by the plastic material may have a stop for the first lever arm, against which the first lever arm abuts in a triggered position, i.e. the end position. This ensures that the lever performs a defined movement when the thermally softenable material loses its mechanical strength, i.e. when the holding force decreases, causing the lever to rotate due to the preloading force of the preloading element. The stop then ensures that the lever only performs a defined rotation, e.g. through an angle of 40°. As the stop is formed by the plastic material itself, the assembly can be designed to be correspondingly simple, since a separately designed stop is not necessary. This ensures that the spring arm assumes a defined end position when the disconnecting device is in the triggered position or the end position.

A further aspect provides that the frame forms a base plate which is substantially parallel to a main section of the stamped metal sheet. The main section of the stamped metal sheet is in particular a section of the stamped metal sheet which is mechanically unprocessed, i.e. has not been reshaped, in particular bent. For example, the main section of the stamped metal sheet corresponds to the first electrode for the electrical component.

The base plate thus represents the base of the frame formed from the plastic material, from which structures project to form functional components of the disconnecting device, for example the bearing for the lever, the stop for the first lever arm or other functional components.

In particular, the base plate has a recess in which the pin of the lever is received so as to be movable. The recess can thus define the maximum possible range of movement of the lever, as the lever can only move in the way that the pin can move within the recess.

In particular, at least one edge of the recess forms a stop point for the pin, at which the pin can abut in a triggered position. This provides a further stop point for the lever, in particular the pin thereof, the movement of the lever in the triggered state being limited, for example to a rotation angle of 40°. This position corresponds to the technical end position of the lever.

Furthermore, the assembly may have an electrical component. The electrical component may be electrically coupled to the holding element, so that there is an electrical connection via the holding element to the electrical component. For this purpose, a solder connection, for example in the form of a solder paste, may be provided between the stamped metal sheet, in particular the first electrode formed by the stamped metal sheet, and the electrical component. The solder connection is advantageous with regard to the thermal function of the disconnecting device.

In principle, the electrical component may be in thermal contact with the stamped metal sheet, for example via the holding element or generally the main section of the stamped metal sheet, which forms the first electrode for the electrical component. Heating of the electrical component leads to heating of the stamped metal sheet, in particular of the first electrode, which in turn causes the holding element, which can be integrally formed with the first electrode from the common stamped metal sheet and contacts the thermally softenable material, to be heated accordingly, thus softening the thermally softenable material. The disconnecting device thus reacts to a heating of the electrical component, causing it to trigger and the thermal separating point to separate. The lever thus presses the spring arm into the technical end position, i.e. the triggered position, due to the preloading force of the preloading element.

At the same time or (directly) in succession, the pin provided on the lever interrupts the mechanical separating point of the remote signaling contact, so that the triggering of the assembly is signaled. Preferably, the pin interrupts the mechanical separating point of the remote signaling contact shortly after the thermal separating point has been opened. This means that the lever or the pin has or have traveled a certain distance before the pin interrupts the mechanical separating point of the remote signaling contact.

The electrical component may be arranged on one side of the stamped metal sheet, in particular the first electrode formed therefrom for the electrical component, which faces away from the spring arm. This results in a compact design, as the mechanically moved parts are arranged on one side of the stamped metal sheet, in particular on one side of the first electrode, whereas the electrical component is arranged on an opposite side of the stamped metal sheet or the first electrode. In particular, the moved components are appropriately separated from the electrical component by the base plate of the frame.

A further aspect provides that a contact plate is arranged on the electrical component, from which a contacting section branches off and extends through an opening in the frame formed by the plastic material. The contact plate represents the second electrode for the electrical component. The electrical component can be electrically contacted via the contact plate and the contacting section, so that a current flow via the electrical component is possible. The contacting section in particular projects perpendicularly from the contact plate. The opening, which is provided in the frame formed by the plastic material, also ensures that a defined arrangement of the contact plate is possible with respect to the assembly. The second plug contact is partially arranged in the opening so that it can be contacted. The contacting section establishes an electrical contact with a second plug contact of the assembly in the area of the opening in the frame, which is also formed from the stamped metal sheet.

The contact plate may be electrically and mechanically attached to the electrical component by means of a solder connection, in particular a solder paste. In principle, the solder connection may also be realized by solder plates. As an alternative to the solder connection, a welded connection or a mechanical connection may also be provided, for example a riveted connection.

The electrical component is, for example, a varistor, in particular a metal oxide varistor.

A gas discharge tube (GDT) may also be provided.

In addition, the frame may form a receptacle for the electrical component. The receptacle ensures that the electrical component is securely held in the frame, as a result of which it has a defined position on the frame. The receptacle can also ensure a mechanical positive fit for the electrical component.

In particular, the receptacle may have a snap connection for mechanically fastening the electrical component to the frame. This provides a mechanical securing of the electrical component, so that further connecting elements can be dispensed with, which further simplifies the assembly of the surge protection apparatus.

The corresponding snap connection may be formed when the stamped metal sheet is insert-molded with the plastic material.

According to a further aspect, the spring arm, at its end opposite the contact point, merges via a pivot point having a material taper into a connecting section which is made from the common stamped metal sheet, the spring arm being pivotable about the pivot point having a material taper. The pivot point having a material taper ensures that the force applied by the lever does not have to be too great to pivot the spring arm about the pivot point. At the same time, the preloading element can be designed with a reduced preloading force, as a result of which the electrical and mechanical connection, which is established via the thermally softenable material, is subjected to less stress. For example, the pivot point having a material taper has an opening, thus creating the material taper.

The connecting section may have been produced by reshaping the stamped metal sheet in sections.

The spring arm may have a first and a second section which extend at an angle to each other, which is different from 0° or 180°, respectively, the second section having the contact point. The appropriately designed spring arm ensures a compact design in which, nevertheless, the largest possible engagement surface for the lever is provided so that the spring arm can be easily pivoted.

The two sections of the spring arm may be aligned with each other such that a kink is formed in the spring arm. The corresponding kink is generated due to the two sections.

The contact point of the spring arm may have a window into which an angled web is inserted, which is soldered to the edge of the window.

In addition, an outer housing may be provided which at least accommodates the frame. In particular, the outer housing surrounds all components of the disconnecting device so that they are protected from the outside. In addition, the outer housing ensures that the clearance and creep distances are maintained.

In particular, the outer housing is hood-like. The outer housing is placed on the frame, which has two (substantially) parallel resting surfaces for the outer housing and a bearing surface perpendicular to the two (substantially) parallel resting surfaces. This ensures that the outer housing is guided upon placement, resulting in a defined position. This makes it easier to assemble the surge protection apparatus.

In particular, the snap connection is formed on the edge section of the frame, which simultaneously provides the bearing surface. The corresponding edge section may be designed to be elastic to ensure the snap connection.

Alternatively or additionally, it may be provided that elastically configured edge sections are formed on sides which are perpendicular to the bearing surface.

In principle, the stamped metal sheet, in particular the stamped grid, may have contacts for the electrical connection, for example contact pins, contact plugs or the like. They make it possible to couple the assembly to a further assembly, in particular by soldering or plugging.

In addition, a surge protection apparatus is provided according to the invention, which has an assembly of the type mentioned above.

The surge protection apparatus may be a surge arrester, i.e. a device or component for limiting dangerous overvoltages in electrical lines and apparatus.

Furthermore, the invention relates to a method of manufacturing an assembly for a surge protection apparatus. The method comprises the following steps:
providing a stamped metal sheet,
forming a remote signaling contact from the stamped metal sheet, wherein the remote signaling contact has a mechanical separating point,
forming a spring arm having an end-side contact point from the stamped metal sheet,
forming a holding element from the stamped metal sheet so that the holding element and the contact point are opposite each other in an initial position of the assembly,
attaching a thermally softenable material between the holding element and the contact point, which connects the spring arm both mechanically and electrically to the holding element, and
at least partially insert-molding the stamped metal sheet with a plastic material so that a frame is formed.

The remote signaling contact, the spring arm and the holding element are thus manufactured from a common stamped metal sheet, which allows the manufacturing costs to be reduced accordingly. It is therefore provided that the remote signaling contact is made of the same material as the spring arm and the holding element.

In particular, the remote signaling contact, the spring arm and/or the holding element are made by reshaping the stamped metal sheet, for example by bending the stamped metal sheet.

When forming the remote signaling contact, the mechanical separating point thereof may be produced by a material tapering, for example by a web which has at least one constriction. It may also be provided that the mechanical separating point is provided with a notch when forming the remote signaling contact.

Furthermore, the spring arm can be manufactured accordingly in the desired manner when the spring arm is formed, i.e. when the stamped metal sheet is reshaped, so that the spring arm has, for example, a pivot point having a material taper.

In addition, a lever may be provided, which has in particular a first lever arm and a second lever arm and which is arranged on a bearing, in particular a bearing formed by the frame.

It is therefore possible to manufacture an assembly of the aforementioned type using the method.

The aforementioned advantages and properties with regard to the assembly also apply in a similar manner to the method.

Further advantages and properties of the invention will become apparent from the description below and from the drawings, to which reference is made and in which:

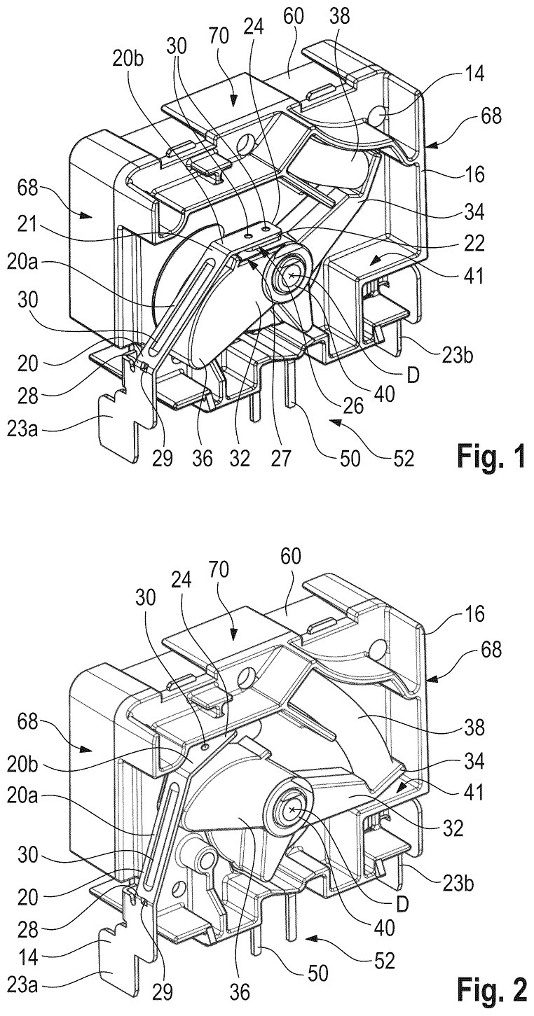

FIG. 1 shows a perspective view of a surge protection apparatus according to the invention with an assembly according to the invention in the initial position,

FIG. 2 shows the surge protection apparatus of FIG. 1 in the triggered position,

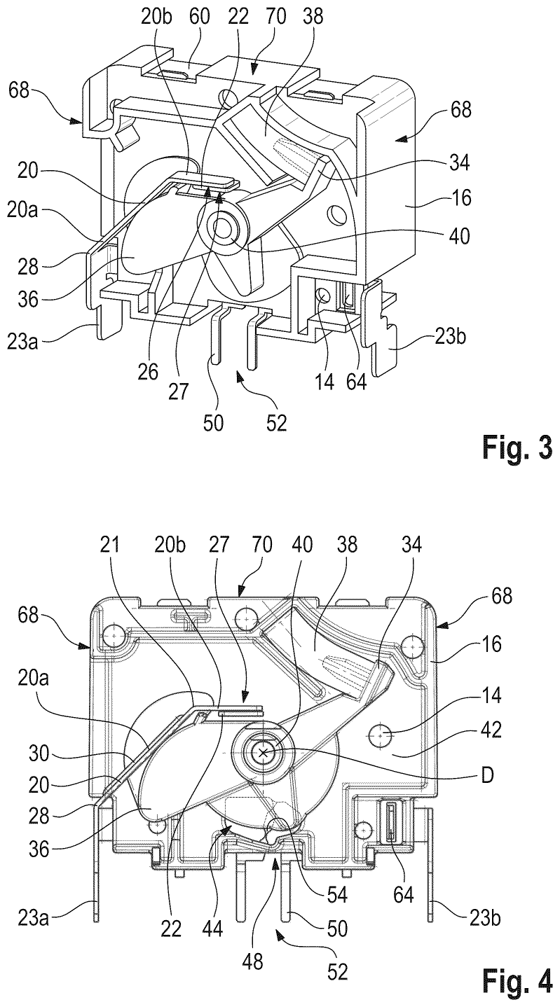

FIG. 3 shows the surge protection apparatus of FIG. 1 in a different perspective view,

FIG. 4 shows the surge protection apparatus of FIG. 1 in a front view,

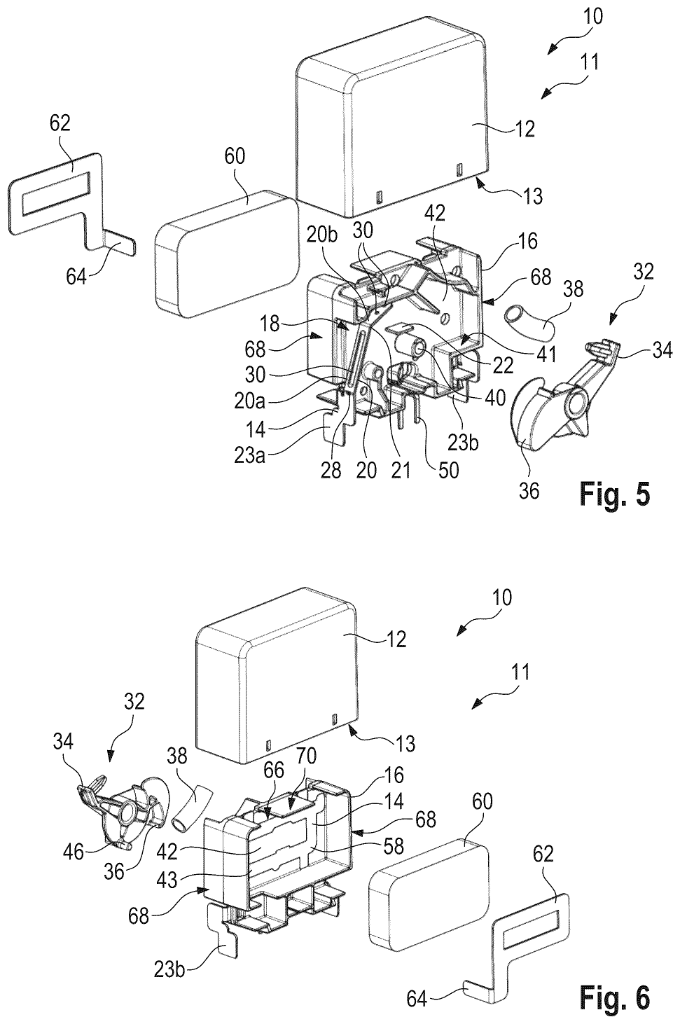

FIG. 5 shows the surge protection apparatus of FIG. 1 in an exploded perspective view,

FIG. 6 shows the exploded view of FIG. 5 in a different perspective,

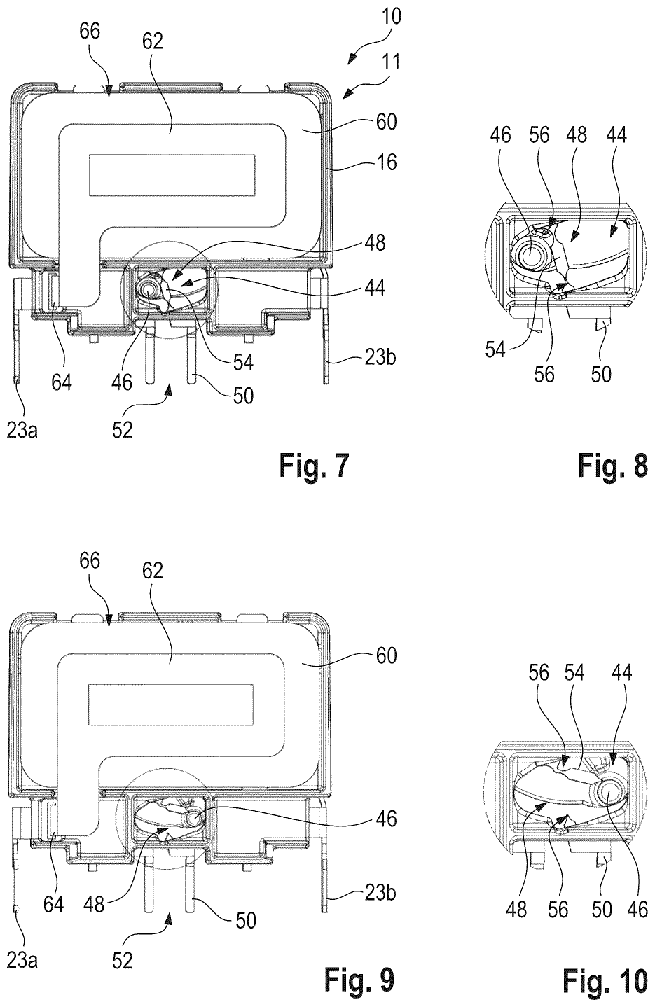

FIG. 7 shows a front view of the remote signaling contact according to a first embodiment in the initial position,

FIG. 8 shows a detailed view of FIG. 7,

FIG. 9 shows the remote signaling contact of FIG. 7 in the triggered position,

FIG. 10 shows a detailed view of FIG. 9,

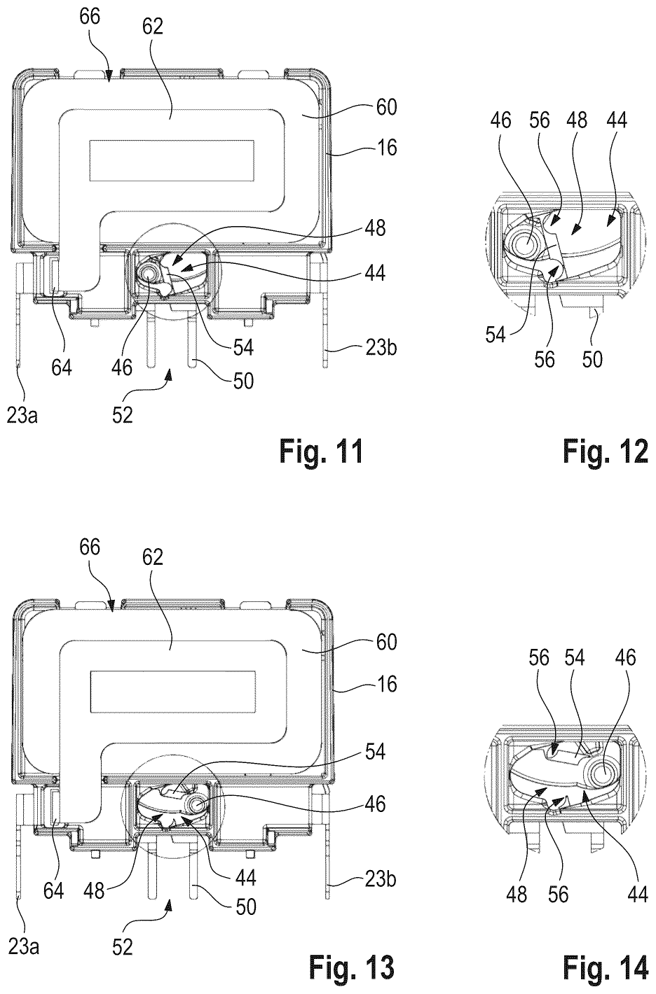

FIG. 11 shows a front view of the remote signaling contact according to a second embodiment in the initial position,

FIG. 12 shows a detailed view of FIG. 11,

FIG. 13 shows the remote signaling contact of FIG. 11 in the triggered position,

FIG. 14 shows a detailed view of FIG. 13,

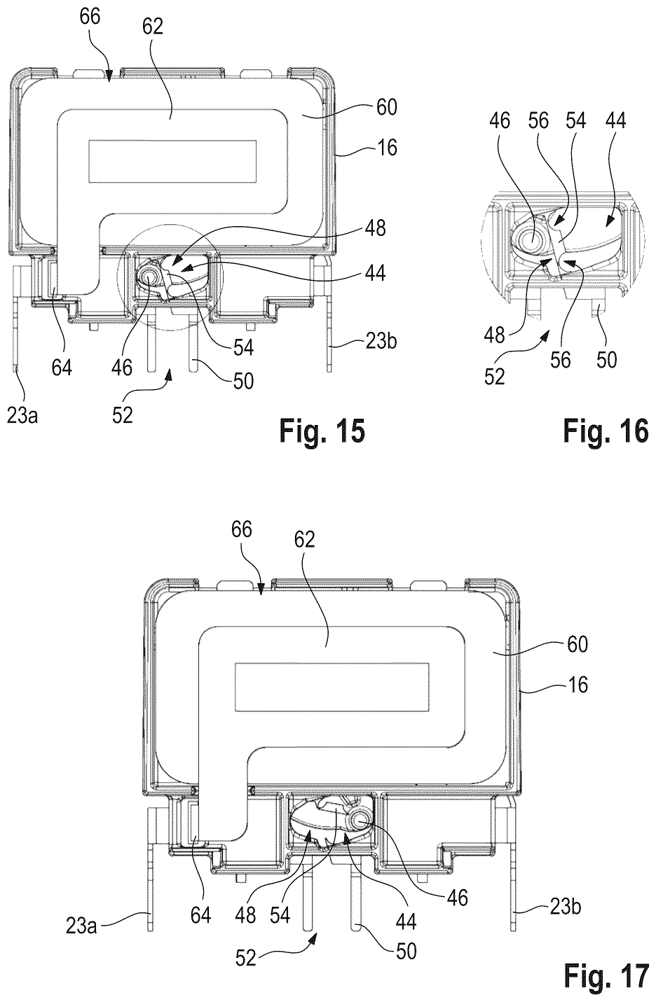

FIG. 15 shows a front view of the remote signaling contact according to a third embodiment in the initial position,

FIG. 16 shows a detailed view of FIG. 15,

FIG. 17 shows the remote signaling contact of FIG. 15 in the triggered position,

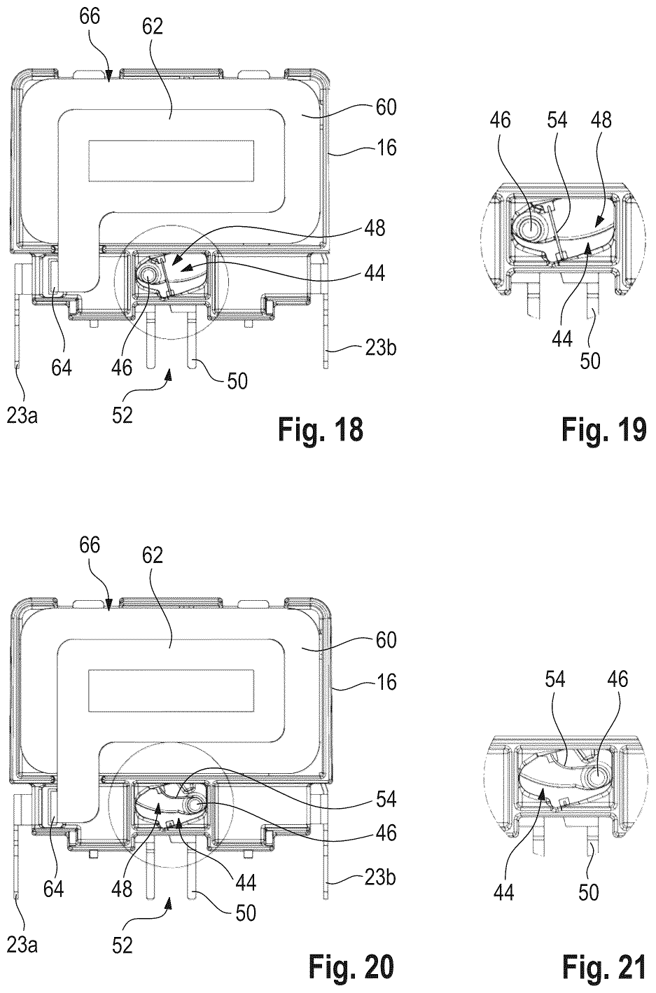

FIG. 18 shows a front view of the remote signaling contact according to a fourth embodiment in the initial position,

FIG. 19 shows a detailed view of FIG. 18,

FIG. 20 shows the remote signaling contact of FIG. 18 in the triggered position,

FIG. 21 shows a detailed view of FIG. 20,

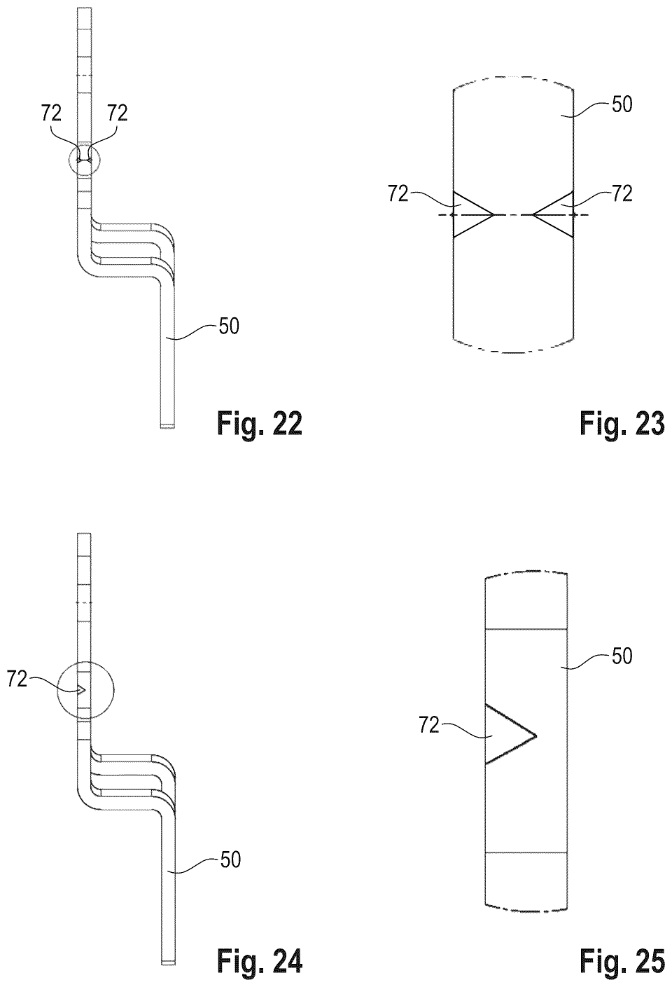

FIG. 22 shows a lateral perspective view of the remote signaling contact according to a variant embodiment,

FIG. 23 shows a partial view of FIG. 22,

FIG. 24 shows a lateral perspective view of the remote signaling contact according to a further variant embodiment,

FIG. 25 shows a partial view of FIG. 24,

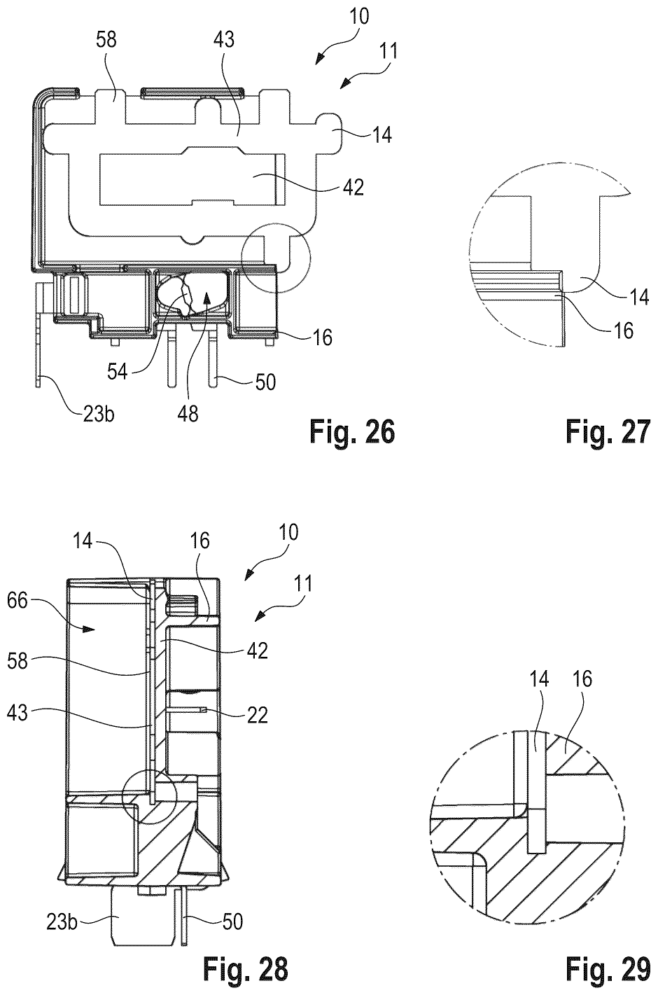

FIG. 26 shows a partially cut representation of the surge protection apparatus of FIG. 1,

FIG. 27 shows a detailed view of FIG. 26,

FIG. 28 shows a side view of the representation of FIG. 26,

FIG. 29 shows a detailed view of FIG. 28, and

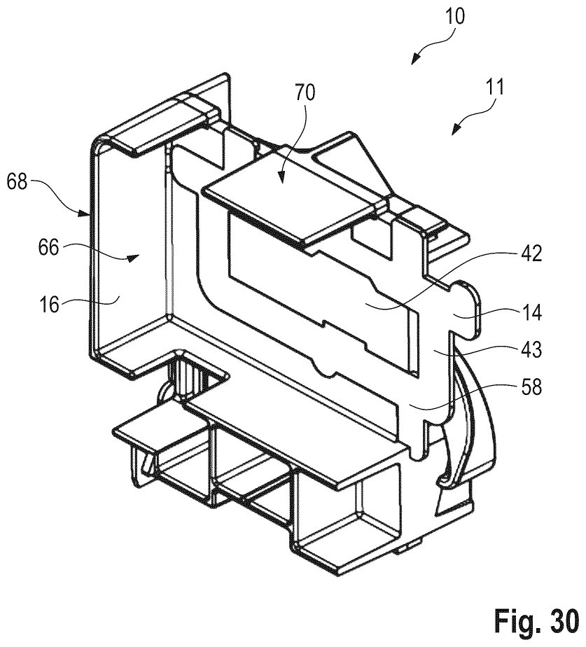

FIG. 30 shows a perspective view of the representation in FIG. 26.

FIGS. 1 to 10 show a surge protection apparatus 10 which is provided for protecting electronic components and has an assembly 11.

The assembly 11 has an outer housing 12 which (completely) surrounds internal components of the surge protection apparatus 10 or the assembly 11.

In particular, the outer housing 12 is hood-like, as can be seen from FIGS. 5 and 6, since the outer housing 12 has only one open side 13.

In addition, the assembly 11 has a stamped metal sheet 14 from which several components of the surge protection apparatus 10 or the assembly 11 are formed, as will be explained below.

The stamped metal sheet 14, or the components formed therefrom, have been at least partially insert-molded by a plastic material which forms a frame 16.

The stamped metal sheet 14 has been mechanically processed by reshaping, in particular by bending sections and contacts, for example. Consequently, a stamped grid is involved which has a three-dimensional shape, as can be seen from the figures.

Furthermore, the assembly 11 comprises a disconnecting device 18 which is composed of several components. The disconnecting device 18 includes, among other things, a spring arm 20 having a first section 20a and a second section 20b which extend at an angle to each other, thus forming a kink 21 between the two sections 20a, 20b.

In addition, the disconnecting device 18 comprises a holding element 22 which cooperates with the spring arm 20, as will be explained below.

The spring arm 20 and the holding element 22 are both produced from the common stamped metal sheet 14 by stamping out and/or reshaping corresponding areas of the stamped metal sheet 14 so that the components are formed. The spring arm 20 and the holding element 22 are thus produced by stamping and/or reshaping the stamped metal sheet 14.

In addition, further components have been formed from the stamped metal sheet 14, in particular the stamped grid, which serve for the electrical connection of the disconnecting device 18, namely a first contact 23a and a second contact 23b, the two contacts 23a, 23b being formed, for example, as contact pins, contact plugs or the like. The contacts 23a, 23b can also have been produced by stamping and/or reshaping the stamped metal sheet 14.

For example, the first contact 23a is formed integrally with the spring arm 20, so that the two components have been stamped together and formed accordingly by reshaping.

The second contact 23b, however, can have been stamped from the stamped metal sheet 14 as a separate component.

The spring arm 20 has a contact point 24, which is formed at a free end of the spring arm 20. In the initial position of the assembly 11, which is shown in FIGS. 1, 3 and 4, the contact point 24 is located opposite the holding element 22, a thermally softenable material 26, for example a solder, being provided between the holding element 22 and the contact point 24.

The thermally softenable material 26 ensures both a mechanical and an electrical connection between the contact point 24 and the holding element 22, which is, however, separable. In this respect, the thermally softenable material 26 forms a thermal separating point 27.

The spring arm 20 merges into the first contact 23a via a pivot point 28 having a material taper.

The pivot point 28 having a material taper is provided at an end of the spring arm 20 opposite the contact point 24, the spring arm 20 being pivotable about the corresponding pivot point 28 having a material taper when the assembly 11 moves into a triggered state, as will be explained below. It is for example provided that the pivot point 28 having a material taper has an opening 29, which improves the pivoting behavior of the spring arm 20 about the pivot point 28 accordingly.

Furthermore, the spring arm 20 has an embossing 30.

The embossing 30 can be provided on the first section 20a to stiffen the spring arm 20. In this respect, the embossing 30 forms a stiffening rib in the first section 20a.

In the second section 20b, at least one embossing 30, in particular two embossings 30, can (also) be provided in the area of the contact point 24 to form spacers. This ensures a defined distance between the contact point 24 and the holding element 22 to adjust the thickness of the thermally softenable material 26, which is provided between the contact point 24 and the holding element 22.

Generally, the assembly 11 also comprises a lever 32 which, in the embodiment shown, includes a first lever arm 34 and a second lever arm 36, via which the lever 32 interacts with a preloading element 38, in particular an elastic preloading element such as a spring, or the spring arm 20.

The preloading element 38 generates a preloading force which acts on the first lever arm 34, causing the lever 32 to rotate about an axis of rotation D. Due to the preloading force, the second lever arm 36 presses against the spring arm 20, which is mechanically fastened to the holding element 22 by means of the thermally softenable material 26 via the contact point 24.

The lever 32, in particular the two lever arms 34, 36, the spring arm 20, the thermally softenable material 26 and the preloading element 38 are adjusted to each other such that the mechanical connection of the thermally softenable material 26 generates a sufficiently high holding force so that the lever 32 initially remains in the initial position shown in FIGS. 1, 3 and 4.

In the event of thermal heating of the thermally softenable material 26, which occurs, for example, when there is an increased current flow via the electrically conductive connection which is produced by the thermally softenable material 26, and/or due to a thermal coupling of a warm component, the thermally softenable material 26 can soften, causing the mechanical connection to generate a lower holding force so that the preloading element 38 moves the lever 32. The lever 32 is thus rotated about the axis of rotation D, which extends through a bearing 40 for the lever 32, which is provided by the plastic material of the frame 16.

When assembling the assembly 11, the lever 32 may have been placed on the bearing 40, so that the lever 32 can be easily mounted on the frame 16.

Upon rotation of the lever 32, the second lever arm 36 engages with the spring arm 20, causing it to pivot about the pivot point 28 having a material taper, so that there is no longer any mechanical or electrical connection between the contact point 24 and the holding element 22, as shown in FIG. 2.

The spring arm 20 is thus pivoted due to the preloading force of the preloading element 38, provided that the thermally softenable material 26, which forms the thermal separating point 27, produces a holding force which is no longer sufficiently high.

The preloading element 38 is designed such that the spring arm 20 reliably reaches its end position when triggered, thus ensuring that no electric arc forms between the contact point 24 and the holding element 22. To this end, it may also be provided that the lever 32 partially covers the holding element 22 when it is in the end position.

The frame 16 formed from the plastic material also forms a stop 41 for the first lever arm 34 of the lever 32, as can be seen in FIG. 2, so that the maximum movement or rotation of the lever 32 is limited by the frame 16.

The corresponding stop 41 is thus formed in one piece with a base plate 42 of the frame 16, which is substantially parallel to a main section 43 of the stamped metal sheet 14, which has not been mechanically deformed.

A recess 44 into which a pin 46 of the lever 32 extends is also provided in the base plate 42, the pin 46 being movably received in the recess 44. An edge of the recess 44 can form a stop point for the pin 46, the freedom of movement of the lever 32 being again limited.

The pin 46 generally serves to open a mechanical separating point 48 of a remote signaling contact 50 when the assembly 11 moves from the initial position to the triggered position, i.e. to the end position. The remote signaling contact 50 is part of a remote signaling circuit 52, via which the state of the assembly 11 or the surge protection apparatus 10 is signaled.

As already described above, the lever 32 moves due to the softening of the thermally softenable material 26 and the preloading force exerted by the preloading element 38, so that the pin 46 performs a pivoting movement and thus interrupts the mechanical separating point 48 of the remote signaling contact 50, thus interrupting the remote signaling circuit 52.

The mechanical separating point 48 is formed by a web 54 which, in the first embodiment (FIGS. 4 and 7 to 10), has two constrictions 56. The two constrictions 56 are each formed by the fact that the web 54 is cut from both sides, i.e. the material thickness of the web 54 tapers from both sides.

In addition, it can be provided that only one of the two constrictions 56, in the present case the constriction 56 shown at the bottom in the figures, has at least one embossing, which ensures that the first constriction 56 functions as an axis of rotation, while the second constriction 56 is separated. The embossing reduces the cross-section and is thus the weakened point. This ensures that the clearance and creep distances are sufficient and that a safe end position is also achieved.

FIGS. 7 to 10 show that the pin 46 is moved against the web 54 when the lever 32 pivots, the mechanical separating point 48 in the area of at least one of the two constrictions 56 being thus separated. The remaining part of the web 54 can then be pivoted around the other of the two constrictions 56 when the lever 32 with the pin 46 moves further in the direction of the end position, as shown in FIGS. 9 and 10. However, when the mechanical separating point 48 is separated, a separation at both constrictions 56 can also occur. In either case, the pin 46 destroys the web 54.

FIGS. 7 and 9 show the back side of the stamped metal sheet 14, in particular the main section 43, which forms a first electrode 58 for an electrical component 60.

The stamped metal sheet 14, in particular the main section 43, is embedded in the frame 16, as can be seen in FIGS. 26 to 30, in which the frame 16 is shown in a partially cut view.

Further components made from the stamped metal sheet 14 can also be at least partially embedded in the frame 16, in particular the section comprising the first contact 23a, the second contact 23b and/or the remote signaling contact 50.

FIGS. 5 and 6 show the electrical component 60, which is designed, for example, as a varistor.

The electrical component 60 is arranged on a side of the stamped metal sheet 14 which faces away from the lever 32, as illustrated in FIGS. 5 and 6.

This ensures that the mechanically moved components of the disconnecting device 18 are arranged on one side of the stamped metal sheet 14, in particular of the main section 43, whereas the electrical component 60 is located on an opposite side of the stamped metal sheet 14.

The electrical component 60 is in electrical contact with the holding element 22 via the first electrode 58. The electrical component 60 is also thermally coupled to the first electrode 58 and thus to the holding element 22.

The thermal and electrical coupling of the electrical component 60 to the first electrode 58, which is formed from the stamped metal sheet 14, is ensured, for example, by a solder connection, in particular by means of a solder paste or a solder molding such as a solder plate. Alternatively, an electrically conductive adhesive can be provided. A welded connection or a mechanical connection can also be provided, for example a riveted connection.

This ensures, among other things, that heating of the electrical component 60 causes the holding element 22, which is made from the stamped metal sheet 14, to heat up. In this way, heat is introduced into the thermal separating point 27, causing the thermally softenable material 26 to heat up. Heating of the electrical component 60 during operation of the surge protection apparatus 10 thus causes the thermally softenable material 26 to heat up, allowing the thermal separating point 27 to trigger.

In addition, a second electrode 62 formed by a contact plate is provided on the electrical component 60. A contacting section 64 extends from the contact plate or the second electrode 62 and extends through an opening in the frame 16 formed by the plastic material. The contact plate or the second electrode 62 can also have been attached to the electrical component 60 by means of a soldered connection, for example a soldering paste or a solder molding such as a solder plate, to ensure an electrical connection. Alternatively, an electrically conductive adhesive can be provided. A welded connection or a mechanical connection can also be provided, for example a riveted connection.

The second electrode 62 is electrically conductively connected to the second contact 23b by means of the contacting section 64.

In this respect, in the initial state, which is shown in FIGS. 1, 3 and 4, a continuous electrical conduction from the first contact 23a to the second contact 23b is achieved, a current flowing from the first contact 23a and the spring arm 20, which is integrally formed therewith, via the electrically conductive and the thermal separating point 27 to the holding element 22, which is integrally connected to the first electrode 58. Via the first electrode 58, the current flows via the electrical component 60 to the second electrode 62, in particular to the contacting section 64, which is electrically conductively connected to the second contact 23b.

In addition, a current can flow via the remote signaling contact 50, the remote signaling circuit 52 being thus closed.

If the assembly 11 or the surge protection apparatus 10 moves from the initial position to the triggered position, i.e. from the start position to the end position, the thermal separating point 27 is opened due to the heating, the lever 32 moving the spring arm 20 into the end position. At the same time, the pin 46 provided on the lever 32 opens the mechanical separating point 48 of the remote signaling contact 50 by destroying the web 54. Thus, a current flow is interrupted via the disconnecting device 18 and at the same time a message is sent via the remote signaling circuit 52.

The frame 16 basically has a receptacle 66 for the electrical component 60, so that the electrical component 60 can be inserted into the frame 16 formed by the plastic material and coupled thereto. The frame 16 thus serves as an insertion aid to ensure the clearance and creep distances.

In addition, the receptacle 66 can have a snap connection by means of which the electrical component 60 can be mechanically attached to the frame 16. To this end, the electrical component 60 is inserted into the receptacle 66 of the frame 16, the snap connection producing a corresponding positive engagement to attach the electrical component 60 to the frame 16.

Furthermore, the plastic material forming the frame 16 ensures that the frame 16 has two (substantially) parallel resting surfaces 68 and a bearing surface 70 perpendicular thereto, which serve to guide and support the outer housing 12.

The hood-like outer housing 12 can thus be placed on the frame 16, the inner sides of the outer housing 12 sliding along the resting surfaces 68 and being thus guided until an inner side of the outer housing 12, which is opposite to the open side 13 of the outer housing 12, rests against the bearing surface 70.

FIGS. 11 to 14 show a second embodiment of the remote signaling contact 50, in which the web 54 has two constrictions 56 which are formed by the web 54 being cut on only one side in the area of the constrictions 56, but starting from opposite sides.

This embodiment also has a defined constriction 56 which acts as an axis of rotation, whereas the other constriction 56 is weakened, for example by at least one embossing, such that it is opened.

FIGS. 15 to 17 show a third embodiment of the remote signaling contact 50, in which the web 54 has two constrictions 56, which are formed by the web 54 being cut on only one side in the area of the constrictions 56, but starting from the same side, in particular the side of the web 54 which points away from the pin 46 in the initial position.

This embodiment also has a defined constriction 56 which acts as an axis of rotation, whereas the other constriction 56 is weakened, for example by at least one embossing, such that it is opened.

FIGS. 18 to 21 show a third embodiment of the remote signaling contact 50, in which the web 54 has a material tapering compared to the resting points, so that the web 54 can be cut when the pin 46 pivots.

For example, the web 54 can be formed by an applied wire with a constriction, which has been bonded, soldered or welded thereon.

FIGS. 22 and 23 show a further embodiment in which the web 54 additionally has notches 72.

In particular, the notches 72 are provided on two opposite sides of the web 54, which are perpendicular to the side from which the at least one incision per constriction 56 is formed in the web 54. In this respect, the notches 72 can be provided in addition to the at least one incision.

FIGS. 24 and 25 show a further variant embodiment in which the web 54 additionally has a notch 72 which is larger than one of the two notches 72 according to the variant embodiment of FIGS. 22 and 23.

The stamped metal sheet 14 insert-molded by the plastic material ensures that the surge protection apparatus 10 or the assembly 11, in particular the disconnecting device 18, has fewer individual parts that have to be laboriously assembled to form the disconnecting device 18, since the thermal separating point 27 is formed by the thermally softenable material 26, the holding element 22 and the contact point 24 of the spring arm 20.

The simple structure is obtained as the spring arm 20, the holding element 22, the remote signaling contact 50, the contacts 23a, 23b and the electrodes 58, 62 have been produced from the stamped metal sheet 14 by stamping and/or reshaping corresponding areas of the stamped metal sheet 14. It is not necessary to provide separate components and couple them together to form the thermal separating point 27.

The plastic material, which has been injected around the stamped metal sheet 14, also provides further components required for the functioning of the disconnecting device 18, for example the bearing 40 for the lever 32, the receptacle 66 for the electrical component 60 and the stop 41 for the lever arm 34 of the lever 32.

Furthermore, the remote signaling contact 50 is provided with the mechanical separating point 48, which is destroyed by means of the lever 32, in particular the pin 46 provided on the lever 32. The mechanical separating point 48 has a web 54 which is cut through by the pin 46. For this purpose, the web 54 can have a taper, for example a constriction 56 and/or a notch 72.

The lever 32, in particular the movement thereof, ensures that the thermal separating point 27 and the mechanical separating point 48 are opened or separated in a defined temporal sequence. Preferably, this occurs in rapid succession, i.e. in chronological order.

This makes assembly of the individual components considerably easier, so that the manufacturing and assembly costs can be reduced.

Basically, the assembly 11 shown can be formed by carrying out a method of manufacturing the assembly.

This method comprises the following steps:
providing a stamped metal sheet 14,
forming a remote signaling contact 50 from the stamped metal sheet 14, wherein the remote signaling contact 50 has a mechanical separating point 48,
forming a spring arm 20 having an end-side contact point 24 from the stamped metal sheet 14,
forming a holding element 22 from the stamped metal sheet 14 so that the holding element 22 and the contact point 24 are opposite each other in an initial position of the assembly 11,
attaching a thermally softenable material 26 between the holding element 22 and the contact point 24, which connects the spring arm 20 both mechanically and electrically to the holding element 22, and
at least partially insert-molding the stamped metal sheet 14 with a plastic material so that a frame 16 is formed.

The remote signaling contact 50, the spring arm 20 and the holding element 22 are thus produced from a common stamped metal sheet 14. In particular, the remote signaling contact 50, the spring arm 20 and/or the holding element 22 are produced by reshaping the individual stamped metal sheet 14, for example by bending the stamped metal sheet 14.

When forming the remote signaling contact 50, the mechanical separating point 48 thereof can be produced by a material taper, for example by the web 54, which has at least one constriction 56 and/or notch 72, as already explained above.

In addition, the lever 54 is arranged on the bearing 40, which is formed in particular by the frame 16.

Therefore, it in in particular possible to manufacture an assembly 11 according to any of the previously discussed embodiments using the method.

1. An assembly for a surge protection apparatus (10), comprising a disconnecting device (18) which includes a spring arm (20) having an end-side contact point (24) and a holding element (22), wherein the holding element (22) and the contact point (24) are opposite each other in an initial position of the assembly (11), and a thermally softenable material (26) is provided between the holding element (22) and the contact point (24) which connects the spring arm (20) both mechanically and electrically to the holding element (22), wherein the assembly (11) has a remote signaling contact (50) which has a mechanical separating point (48), wherein the spring arm (20), the holding element (22) and the remote signaling contact (50) are produced from a common stamped metal sheet (14), and wherein the stamped metal sheet (14) is at least partially insert-molded with a plastic material which forms a frame (16).

2. The assembly according to claim 1, characterized in that a thermal separating point (27) between the holding element (22) and the contact point (24) is formed by means of the thermally softenable material (26).

3. The assembly according to claim 1, characterized in that the thermally softenable material (26) is a solder.

4. The assembly according to claim 1, characterized in that the assembly (11) has a lever (32) which is used for the mechanical separation of the mechanical separating point (48) of the remote signaling contact (50) and/or for the defined opening of the connection between the holding element (22) and the contact point (24).

5. The assembly according to claim 4, characterized in that the lever (32) has a first lever arm (34) which cooperates with a preloading element (38), in particular wherein the preloading element (38) is an elastically preloaded preloading element, in particular wherein the lever (32) has a second lever arm (36) which is opposite to the first lever arm (34), wherein the second lever arm (36) acts on the spring arm (20).

6. The assembly according to claim 4, characterized in that a pin (46) is provided on the lever (32) and interacts with the mechanical separating point (48) of the remote signaling contact (50).

7. The assembly according to claim 4, characterized in that the frame (16) formed from the plastic material comprises a bearing (40) for the lever (32) and/or in that the frame (16) formed from the plastic material has a stop (41) for the first lever arm (34) of the lever (32), against which the first lever arm (34) can abut in a triggered position.

8. The assembly according to claim 1, characterized in that the frame (16) forms a base plate (42) which is substantially parallel to a main section of the stamped metal sheet (14).

9. The assembly according to claim 8, characterized in that the base plate (42) has a recess (44) in which the pin (46) of the lever (32) is received so as to be movable, in particular wherein at least one edge of the recess (44) forms a stop point for the pin (46), against which the pin (46) can abut in a triggered position.

10. The assembly according to claim 1, characterized in that the assembly (11) comprises an electrical component (60), in particular wherein the electrical component (60) is arranged on a side of the stamped metal sheet (14) which faces away from the spring arm (20).

11. The assembly according to claim 10, characterized in that a contact plate is arranged on the electrical component (60), from which a contacting section (64) branches off and extends through an opening in the frame (16) formed by the plastic material.

12. The assembly according to claim 10, characterized in that the electrical component (60) is a varistor.

13. The assembly according to claim 10, characterized in that the frame (16) forms a receptacle (66) for the electrical component (60), in particular wherein the receptacle (66) has a snap connection for mechanically fastening the electrical component (60) to the frame (16).

14. The assembly according to claim 1, characterized in that the spring arm (20), at its end opposite the contact point (24), merges via a pivot point (28) having a material taper into a connecting section which is produced from the common stamped metal sheet (14), wherein the spring arm (20) is pivotable about the pivot point (28) having a material taper.

15. The assembly according to claim 1, characterized in that the spring arm (20) has a first section (20a) and a second section (20b) which extend at an angle to each other which is different from 0° and 180° respectively, wherein the second section (20b) has the contact point (24), in particular wherein the two sections (20a, 20b) of the spring arm (20) are aligned with respect to each other such that a kink (21) is formed in the spring arm (20).

16. The assembly according to claim 1, characterized in that an outer housing (12) is provided which receives at least the frame (16).

17. The assembly according to claim 16, characterized in that the outer housing (12) is hood-like and is placed on the frame (16), which has for the outer housing (12) two substantially parallel resting surfaces (68) and a bearing surface (70) perpendicular to the two substantially parallel resting surfaces (68).

18. A surge protection apparatus having an assembly (11) according to claim 1.

19. The surge protection apparatus according to claim 18, characterized in that the surge protection apparatus (10) is a surge arrester.

20. A method of manufacturing an assembly (11) for a surge protection apparatus (10), comprising the following steps:
providing a stamped metal sheet (14),
forming a remote signaling contact (50) from the stamped metal sheet (14), wherein the remote signaling contact (50) has a mechanical separating point (48), forming a spring arm (20) having an end-side contact point (24) from the stamped metal sheet (14),
forming a holding element (22) from the stamped metal sheet (14) so that the holding element (22) and the contact point (24) are opposite each other in an initial position of the assembly (11),
attaching a thermally softenable material (26) between the holding element (22) and the contact point (24) which connects the spring arm (20) both mechanically and electrically to the holding element (22), and
at least partially insert-molding the stamped metal sheet (14) with a plastic material so that a frame (16) is formed.
